(19) United States
(12) Patent Application Publication
(10) Pub. No.: US 2012/0311111 A1
(43) Pub. Date: Dec. 6, 2012

(54) DYNAMIC RECONFIGURATION OF CLOUD RESOURCES

(75) Inventors: Iain R. Frew, Duvall, WA (US); Alireza Farhangi, Kirkland, WA (US)

(73) Assignee: MICROSOFT CORPORATION, Redmond, WA (US)

(21) Appl. No.: 13/152,267

(22) Filed: Jun. 3, 2011

(51) Int. Cl. G06F 15/177

(52) U.S. Cl. 709/221

(57) ABSTRACT

A cloud configuration system is described herein that provides the ability to dynamically reconfigure a set of computing resources to define a cloud into multiple separate logical cloud instances. The system includes a reconfiguration tool that reads an existing system and network configuration from a configuration store, allows the user to change the configuration into multiple logical systems, performs some syntactical checks, and stores the new configuration into the configuration store. The system also includes a validation tool that imports the existing and new configurations from the configuration store, determines what devices need to be changed in the network, and enables a deployment engine to proceed with the changes. The deployment engine applies each change until all changes are completed. The validation tool can then revalidate the post-deployment changes to make sure the new inventory is recognized and no existing setting is broken.

### BACKGROUND

Datacenters provide servers for running large applications. Enterprises often use datacenters to run core business functions such as sales, marketing, human resources, billing, product catalogs, and so forth. Datacenters may also run customer-facing applications, such as web sites, web services, email hosts, databases, and many other applications. Datacenters are typically built by determining an expected peak load and providing servers, network infrastructure, cooling, and other resources to handle the peak load level. Datacenters are known for being very expensive and for being underutilized at non-peak times. They also involve a relatively high management expense in terms of both equipment and personnel for monitoring and performing maintenance on the datacenter. Because almost every enterprise uses a datacenter of some sort, there are many redundant functions performed by organizations across the world.

Cloud computing has emerged as one optimization of the traditional datacenter. A cloud is defined as a set of resources (e.g., processing, storage, or other resources) available through a network that can serve at least some traditional datacenter functions for an enterprise. A cloud often involves a layer of abstraction such that the applications and users of the cloud may not know the specific hardware that the applications are running on, where the hardware is located, and so forth. This allows the cloud operator some additional freedom in terms of rotating resources into and out of service, maintenance, and so on. Clouds may include public clouds, such as MICROSOFT™ Azure, Amazon Web Services, and others, as well as private clouds, such as those provided by Eucalyptus Systems, MICROSOFT™, and others. Companies have begun offering appliances (e.g., the MICROSOFT™ Azure Appliance) that enterprises can place in their own datacenters to connect the datacenter with varying levels of cloud functionality.

Enterprises with datacenters incur substantial costs building out large datacenters, even when cloud-based resources are leveraged. Enterprises often still plan for “worst-case” peak scenarios and thus include an amount of hardware at least some of which is rarely used or underutilized in terms of extra processing capacity, extra storage space, and so forth. This extra amount of resources incurs a high cost for little return. Customers using cloud based computing on premise, such as the appliances described above, expect to be able to use capacity in another compatible cloud (e.g., a second instance of their own in another location, Microsoft's public cloud, and so forth) for peak capacity times, for disaster recovery scenarios, or just for capacity management. Doing so is much less expensive than building out for the worst-case scenario and then doubling for redundancy.

### SUMMARY

A cloud configuration system is described herein that provides the ability to dynamically reconfigure a set of computing resources to define a cloud into multiple separate logical cloud instances. By performing this step automatically, the system reduces the time and effort involved and minimizes potential human-induced errors. The system includes a reconfiguration tool that runs from a utility server with access to a configuration store that manages the cloud configuration. The reconfiguration tool reads an existing system and network configuration from a configuration store, allows the user to change the configuration into multiple logical systems, performs some syntactical checks, and stores the new configuration into the configuration store. The system also includes a validation tool. The validation tool also runs from the utility server, imports the existing and new configurations from the configuration store, and determines what devices need to be changed in the network. The validation tool then validates that the devices are running, can be accessed with existing credentials, and that the settings on the devices do not conflict with the new settings. If all is well, the tool will stamp the new settings as validated and enable a deployment engine to proceed with the changes. The deployment engine applies each change and watermarks the progress in the configuration store until all changes are completed. The validation tool can then revalidate the post-deployment changes to make sure the new inventory is recognized and no existing setting is broken. Thus, the cloud configuration system provides a way to automatically deploy new server configurations with sufficient automatic checking to know that the new configuration will work before it is deployed and to know that the deployment was successful after it is deployed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the cloud configuration system, in one embodiment.

FIG. 2 is a flow diagram that illustrates processing of the cloud configuration system to receive new configuration information for deploying new hardware to a datacenter, in one embodiment.

FIG. 3 is a flow diagram that illustrates processing of the cloud configuration system to deploy a previously defined new datacenter configuration, in one embodiment.

FIG. 4 is a block diagram that illustrates various interactions between components of the system, in one embodiment.

### DETAILED DESCRIPTION

Installing and deploying cloud environments that may include thousands of server nodes takes a considerable amount of time and effort. Once a cloud is configured and operational, changing the cloud's configuration means redeploying the hardware into a new configuration, which is effectively building out a new cloud. Organizations spend a large amount of time on reconfigurations, and thus they will often overbuild datacenters at the outset to avoid needing to reconfigure for a long time. This leads to wasted resources that would not be needed if the organization could have confidence that reconfiguration on a running cloud could occur without disrupting services.

A cloud configuration system is described herein that provides the ability to dynamically reconfigure a set of computing resources (e.g., server, storage, and network nodes) to define a cloud into multiple separate logical cloud instances. Clouds can be flexibly defined to include a number of locations, specific resources at each location, and so forth. A particular definition of a cloud, which specifies the resources available to the cloud, is called a cloud instance. By performing the defining step automatically, the system reduces the time and effort involved and minimizes potential human-induced errors. The need to reconfigure existing fixed machines resources into multiple cloud instances can occur frequently in datacenters with growing demand for handling client requests. The cloud configuration system allows reconfiguration to occur without rebuilding/deploying multiple clouds from a set of fixed hardware resources. The system includes a reconfiguration tool that runs from a utility server (e.g., a server that resides in the datacenter for the use of management and other tools) with access to a configuration store that manages the cloud configuration. The reconfiguration tool reads an existing system and network configuration from the configuration store, allows the user to change the configuration into multiple logical systems (specifying the number of nodes, virtual local area networks (VLANs), dynamic Internet Protocol (IP) addresses (DIPs), Virtual IP addresses (VIPs), and so forth within each logical system), performs some syntactical checks, and stores the new configuration into the configuration store.

The system also includes a validation tool. The validation tool also runs from the utility server, imports the existing and new configurations from the configuration store, and determines what devices need to be changed in the network. The validation tool then validates that the devices are running, can be accessed with existing credentials, and that the settings on the devices do not conflict with the new settings. If all is well, the tool will stamp the new settings as validated and enable a deployment engine to proceed with the changes. The deployment engine applies each change and watermarks the progress in the configuration store until all changes are completed. Watermarking stores information describing each change and is similar to transactional processing in which each change is journaled and can be rolled back. The validation tool can then revalidate the post-deployment changes to make sure the new inventory is recognized and no existing setting is broken (e.g., the datacenter is operating as the administrator would expect, and previous functionality still works). Thus, the cloud configuration system provides a way to automatically deploy new server configurations with sufficient automatic checking to know that the new configuration will work before it is deployed and to know that the deployment was successful after it is deployed.

Adding capacity to a datacenter involves the following high-level steps: 1) phase zero guidance for the expansion, 2) purchasing the new hardware, 3) phase 1 planning to introduce the new hardware to an existing datacenter, 4) pre-deployment validation of existing infrastructure's health, 5) execution: appending the existing hardware and network inventory and modifying the existing network devices, and 6) post-deployment validation of the added nodes and changes to existing infrastructure. Each of these steps is described further below.

Phase zero guidance for the expansion involves a customer providing a count of new racks and a count of new nodes inside each rack, the new DIP and VIP virtual local area networks (VLANs), the location where the new hardware will be placed (e.g., in which cluster and under which load balancer (LB)). The purpose of this phase is to measure available capacity in both network devices and logical network resources, and to provide guidance on how much capacity the user can add, what oversubscription is recommended, and what changes the user needs to make during addition of capacity. This step could be as simple as providing a guideline document for the highest recommended capacity, or as sophisticated as an interactive planning tool. The data generated in this phase may be stored in the configuration store.

The customer then purchases new hardware according to the guidelines provided in phase zero. Phase one begins with planning for the introduction of the new hardware into the datacenter. This phase is similar to the planning phase of initial deployment. The user receives the original equipment manufacturer (OEM) information including Media Access Control (MAC) addresses, asset numbers, and rack stock keeping units (SKUs) along with the new hardware. The user also has any new DIP, DRIP, and VIP pool allocated. The user enters all this information into the planning tool, where the information is validated against existing inventory and then stored in the configuration store to be used by a fabric controller.

The system next provides pre-deployment validation. At this step, the system ensures that all the components that the system will interact with, such as fabric controllers, load balancers, and access routers, are available, credentials are up-to-date, and the devices are responding. The system will perform any specific network validation that will be impacted during the datacenter expansion such as routes. This means determining whether there are enough IP addresses left in the defined VLANs, ensuring the LBs are not populated beyond recommended capacity, and so forth.

Following validation, the system can apply the new configuration to the datacenter. This may include adding racks to a compute node by adding assets to an asset database tracker, adding nodes to a fabric inventory, adding new VLANs to the fabric inventory, adding new VLANs, routes, DRIPs, VIPs, and access control lists (ACLs) to an access router, and adding new DIPs and VIPs to load balancers. In some cases, adding storage racks may be simpler, such as for storage VLANs (e.g., SQL Azure) that can hold up to 1000 nodes. If a cloud-computing appliance includes fewer nodes, then there is plenty of room to grow in the storage clusters.

Post-deployment validation turns on the nodes and verifies that the nodes can reach the fabric controller and can get to “Ready” state. The validation also verifies that existing routes and settings are not impacted. Following post-deployment validation, the datacenter is once again available for use, with the new hardware having been automatically deployed and configured. Applications that use the fabric controller to run on a cloud-based datacenter will find the new hardware and software resources available.

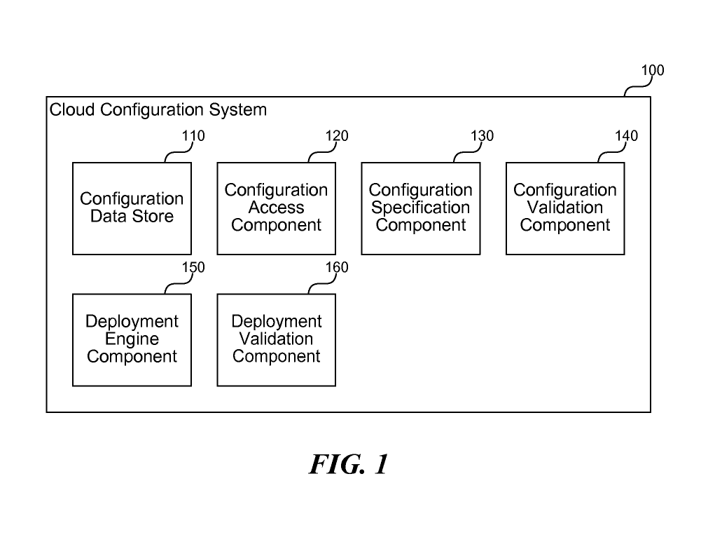

FIG. 1 is a block diagram that illustrates components of the cloud configuration system, in one embodiment. The system 100 includes a configuration data store 110, a configuration access component 120, a configuration specification component 130, a configuration validation component 140, a deployment engine component 150, and a deployment validation component 160. Each of these components is described in further detail herein.

The configuration data store 110 stores configuration information describing the hardware components, software components, and configuration of one or more datacenter resources. The resources may include computer systems, storage devices, network devices, and other resources that make up one or more cloud instances of a cloud-based datacenter. The data store 110 may include one or more files, file systems, hard drives, storage area networks, databases, cloud-based storage services, or other facilities for persisting data over time. The configuration data store 110 may include information describing an active deployment as well as one or more new or potential future deployment configurations defined by an administrator for deployment to the datacenter resources.

The configuration access component 120 retrieves configuration information from the configuration data store 110. The component 120 provides the retrieved information to one or more tools or other applications, such as through a programmatic application-programming interface (API). The configuration access component 120 may provide an object model or other facility for modeling and describing the resources available within the datacenter. In some embodiments, a recarve or reconfiguration tool invokes the configuration access component 120 to access a current configuration for modification into a new configuration. In some cases, an administrator may have purchased new computers to be incorporated into the datacenter or may have made other changes in the datacenter for which reconfiguration is needed.

The configuration specification component 130 receives a description of a new configuration for the datacenter resources. The new configuration may include different roles for various servers, different network configuration, different relationships with other datacenters and/or cloud instances, and so forth. The servers and other resources may include some resources that are present in the current configuration and other resources that are being added because of the reconfiguration, such as when new hardware is purchased and added to the datacenter. The configuration specification component 130 may provide an API or other interface for modifying and receiving new configuration data. In some embodiments, an administrator uses a reconfiguration tool to access the current configuration from the configuration access component 120 and specify a new configuration through the configuration specification component 130. The component 130 stores the new configuration in the configuration data store 110.

The configuration validation component 140 validates the received description for each new configuration of the datacenter resources. Validation may include ensuring that particular computers can communicate based on specified network settings, verifying that a particular server is not overloaded, verifying that sufficient resources are available for performing a particular task, and so forth. The validation component 140 ensures that a configuration is valid before that configuration is deployed into the datacenter. This allows the administrator to catch errors before they result in datacenter interruptions and wasted time. The administrator may invoke a validation tool provided by the system 100 through which the administrator can receive an analysis of verifying a specified configuration. The administrator may create and store several possible configurations for different purposes before the configurations are deployed. For example, a particular cloud may have a default configuration and a configuration that is used during high activity periods (e.g., the holiday season when an online retailer may face high order quantities).

The deployment engine component 150 receives a selection of a new configuration for the datacenter resources and applies the configuration by modifying configuration of hardware and software components to carry out the new configuration. The deployment engine component 150 determines a delta between a current configuration and the new configuration and invokes one or more hardware and software configuration interfaces to apply the differences determined by the delta. The differences may include installing or removing software from computer systems, setting up one or more VIPs or DIPs, performing other configuration of networking resources, configuring processors or other resources on each computer, installing drivers or other software, receiving credential and role information, and so forth. The deployment engine component 150 transitions the set of resources from the current configuration to the new configuration, and results in a datacenter that matches the information specified in the new configuration.

The deployment validation component 160 validates the applied new configuration to catch any errors not identified by the pre-deployment validation. In some cases, the system 100 may be unable to detect some configuration errors or other problems until after the configuration is deployed. The deployment validation component 160 may run one or more smoke tests, connectivity tests, application verification tests, and so forth to determine a level of health and functionality of the datacenter resources following the deployed new configuration. In some embodiments, the system 100 may provide functionality for rolling back a failed reconfiguration so that the system 100 leaves the datacenter resources in a usable former state if a new configuration cannot be successfully applied. The automation of these actions reduces the time that the datacenter resources are unavailable and reduces the risk of reconfiguration datacenter resources. In some embodiments, the system 100 learns from past deployment errors to make the pre-deployment validation more robust so that more potential errors are detected while the administrator is specifying a new configuration rather than after the configuration is already deployed.

The computing device on which the cloud configuration system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

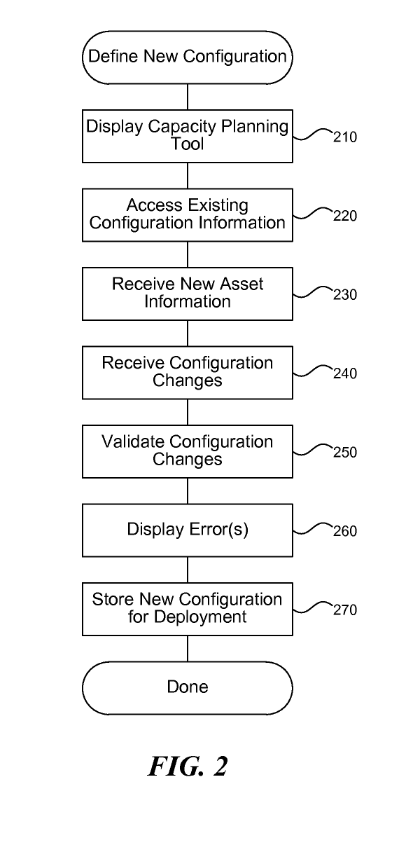

FIG. 2 is a flow diagram that illustrates processing of the cloud configuration system to receive new configuration information for deploying new hardware to a datacenter, in one embodiment. Beginning in block 210, the system displays a capacity-planning tool to an administrator through which the administrator can specify information about new hardware to be automatically deployed in the datacenter. The capacity-planning tool may include one or more user interfaces, including graphical user interface, web-based interface, console user interface, and so forth. The capacity-planning tool may display textual, graphical, or other information about a current configuration of the datacenter as well as one or more resources available for deployment into the datacenter (e.g., particular rack SKUs, available connections, and so forth).

Continuing in block 220, the system accesses information describing a current configuration of the datacenter from a configuration data store. The information may include a list of hardware and software deployed in the datacenter, as well as one or more configuration settings that define routes, addresses, capacities, and so on related to the resources in the datacenter. The system may access the information through a programmatic API or other interface provided by the system for accessing the configuration data store that stores the configuration information.

Continuing in block 230, the system receives information describing one or more new assets from the administrator for deployment into the datacenter. The assets may include new rack SKUs, network hardware, storage instances, and so forth. The asset information may include MAC addresses, processing capabilities, memory or other storage capacity, asset identifiers, and so on.

Continuing in block 240, the system receives one or more configuration changes that specify how a new configuration will differ from the current configuration. The configuration changes may include assigning a pool of IP addresses to one or more new resources, assigning one or more roles to particular hardware resources, specifying credentials and routes for access between one or more resources, and so on. The system may receive the configuration changes through a programmatic API or other interface. The system may store configuration information at various stages, such as during editing, pre-validation, post-validation, pre-deployment, post-deployment, when errors occur, and so forth.

Continuing in block 250, the system validates the received configuration changes to determine whether the new configuration will cause any errors in the datacenter. Errors may include breaking one or more routes or functions that previously worked, creating inaccessible servers, and so forth. The system performs a level of validation designed to identify configuration errors before deployment so that the actual deployment has a high likelihood of success.

Continuing in block 260, upon detecting any configuration errors, the system displays each configuration error to the administrator for resolution. Displaying errors at the time of new configuration specification allows the administrator to correct the errors at the time of lowest cost (i.e., as close to when they occur as possible). In an ideal implementation, the system will only allow configurations of the datacenter to be deployed that will be successful and not cause any errors. However, there may be some types of errors that cannot be detected or are difficult to detect in advance.

Continuing in block 270, the system stores the validated new configuration in the configuration data store for subsequent deployment to the datacenter. The administrator may repeat these steps to produce several alternative configurations, one or more of which may be deployed at various times and under various conditions determined by the administrator. After block 270, these steps conclude.

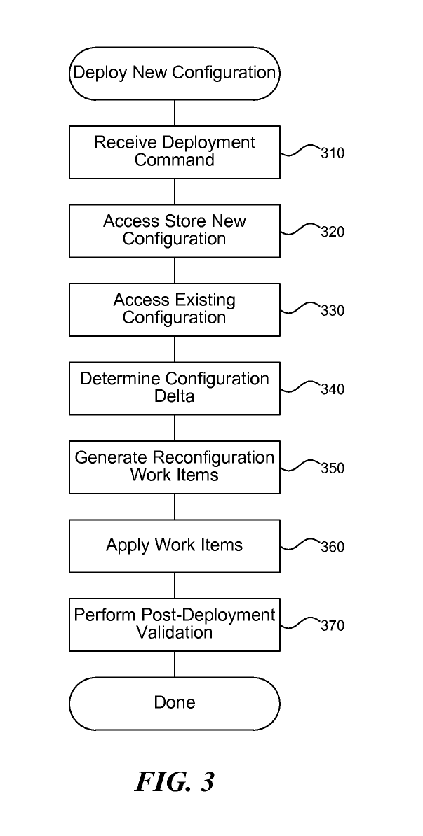

FIG. 3 is a flow diagram that illustrates processing of the cloud configuration system to deploy a previously defined new datacenter configuration, in one embodiment. Beginning in block 310, the system receives a command from an administrator that instructs the system to deploy a previously defined new configuration to a datacenter. The configuration changes may include the addition of new hardware to the datacenter, defining networking routes to the new hardware, reconfiguring previously existing hardware, and so forth. The configuration may also modify roles, credentials, or other software configuration for using the old and new hardware together. The system may receive the deployment command from a deployment tool run by the administrator. The tool may provide a user interface through which the administrator can select from one or more available configurations to deploy and provide other parameters and instructions. The interface may also provide output to the administrator describing specific actions taken by the system, errors encountered, and so on.

Continuing in block 320, the system accesses the previously defined new configuration from a configuration data store associated with the datacenter. The configuration data store may include a hardware and software inventory of resources in the datacenter, and one or more configuration specifications that define how the hardware is or can be configured. The configuration data store may include a database, and accessing the new configuration may include querying the new configuration from the database and providing the configuration information to one or more tools for determining how to deploy the configuration.

Continuing in block 330, the system accesses a current configuration of the datacenter with which to compare the new configuration to determine changes. The current configuration specifies the layout and configuration of the datacenter prior to any added hardware and before the configuration changes specified by the new configuration are applied to the datacenter.

Continuing in block 340, the system determines a configuration delta between the current configuration and the new configuration. The delta may include identifying each resource that will need to change to apply the new configuration and individual configuration changes to apply to the datacenter. In some embodiments, the system may display the delta to the administrator and/or store the delta in the configuration data store for further analysis and validation.

Continuing in block 350, the system generates one or more reconfiguration work items that together will transition the configuration of the datacenter from the current configuration to the new configuration. The work items may include individual resource and configuration change, interfaces through which the changes will occur, and so forth. The system may display the generated work items to the administrator for validation or information and may store the work items in the configuration data store. In some embodiments, the system performs reconfiguration in a transactional manner by monitoring the application of each work item and rolling back previous work items if any work item fails to complete.

Continuing in block 360, the system applies the generated reconfiguration work items to automatically reconfigure the datacenter from the current configuration to the new configuration. Applying the work items may include invoking one or more configuration interfaces provided by resources within the datacenter for specifying configuration information. For example, servers may provide a management interface, networking hardware may provide a protocol for communication configuration information, and so on. The system performs each work item and notes the result so that failures or errors can be handled by the administrator or rolled back automatically by the system.

Continuing in block 370, the system performs post-deployment validation to verify successful reconfiguration of the datacenter. The validation may include running one or more tests to verify expected connectivity between servers, attempting to access storage and other network resources, testing credentials and access to particular resources, and so on. If the system determines that the reconfiguration was successful, then the system informs the administrator of the successful deployment. After block 370, these steps conclude.

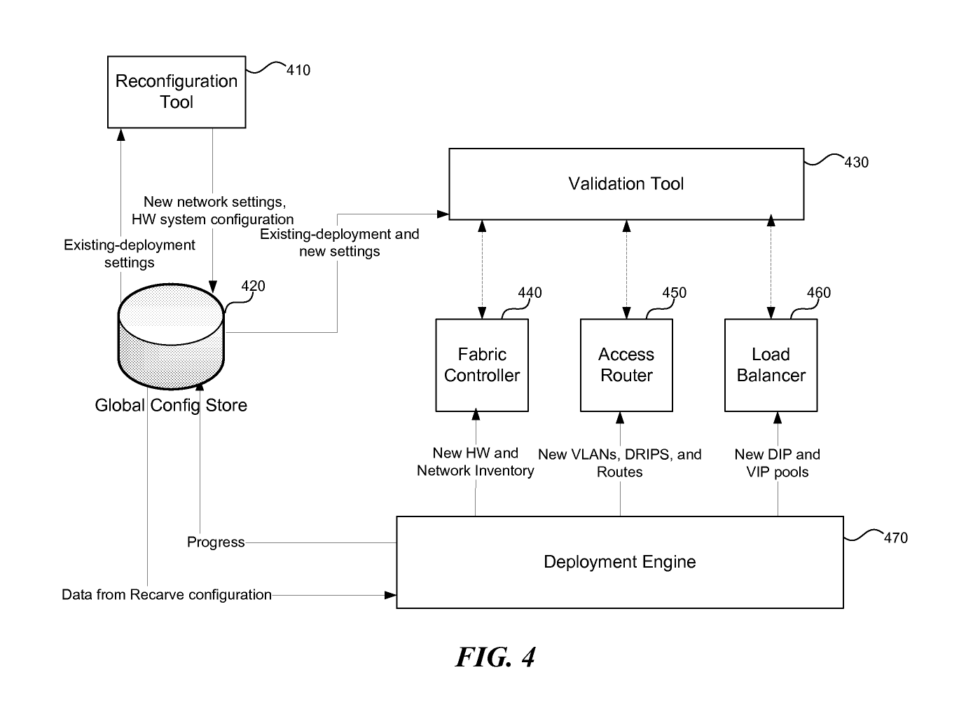

FIG. 4 is a block diagram that illustrates various interactions between components of the system, in one embodiment. A reconfiguration tool 410 runs from a utility server with access to the configuration store 420. The reconfiguration tool 410 captures the input described above from an administrator and performs syntactical checks as an initial validation of the input. The tool 410 stores received configuration changes in the configuration store 420. A validation tool 430 also runs from the utility server, imports the existing and new configuration from the configuration store 420, and determines what devices need to be changed in the network to effect the new configuration. The validation tool 430 then validates that the devices are running, can be accessed with existing credentials, and the settings on them do not conflict with new settings. The validation tool 430 will then stamp the new settings as validated and enable the deployment engine 470 to proceed with the changes. The deployment engine 40 will apply each change and watermark the progress in the configuration store 429 until all changes are completed. The changes may include modifying one or more fabric controllers 440, access routers 450, and load balancers 460. After deployment the validation tool 430 re-validates the post-deployment changes to make sure the new inventory is recognized and no existing setting is broken.

In some embodiments, the cloud configuration system tests the existing datacenter to determine an amount of new capacity needed to satisfy a requirement specified by the administrator. For example, the administrator may want to double the number of client requests serviced by the datacenter over a period. The system can sample the existing datacenter hardware and other resources, and determine new resources that would be needed to satisfy the new conditions. The system can provide this information to the administrator or other information technology (IT) personnel who can then purchase additional datacenter resources.

In some embodiments, the cloud configuration system determines the existing configuration by querying resources within the datacenter. Although it is desirable to maintain all configuration information in one place in a global configuration data store, the system may also provide an ability to gather configuration information that is currently deployed in the datacenter. The system can use this information to validate that changes have not been made manually since the last configuration deployment or to gather information about an existing datacenter to which the system is being deployed for the first time. In many datacenters, it is difficult for administrators to even know what they have, as many hardware purchases may have occurred over time.

In some embodiments, the cloud configuration system determines whether a configuration requested by an administrator is possible before the configuration is deployed. For example, the administrator may want to determine if existing datacenter resources can be redeployed to add a new capability, such as segregating test servers from production servers. The system can determine whether the new configuration will still be able to service nominal or peak demand experienced by the datacenter, or whether the new configuration would cause other problems. This allows the administrator to determine both what he can do with what he has and what he will need to do more, in terms of additional purchasing requirements.

From the foregoing, it will be appreciated that specific embodiments of the cloud configuration system have been described herein for purposes of illustration, but that various modifications may be made without deviating from the spirit and scope of the invention. For example, although cloud-computing environments have been used in examples, the system can also be used with a variety of other types of public and private datacenters. Accordingly, the invention is not limited except as by the appended claims.

I/We claim:

1. A computer-implemented method to receive new configuration information for modifying configuration of a datacenter, the method comprising:
displaying a capacity planning tool to an administrator through which the administrator can specify information about new hardware to be automatically deployed in the datacenter;
accessing information describing a current configuration of the datacenter from a configuration data store;
receiving information describing one or more new assets from the administrator for deployment into the datacenter;
receiving one or more configuration changes that specify how a new configuration will differ from the current configuration;
validating the received configuration changes to determine whether the new configuration will cause any errors in the datacenter before applying the new configuration to the datacenter; and
storing the validated new configuration in the configuration data store for subsequent deployment to the datacenter,
wherein the preceding steps are performed by at least one processor.

2. The method of claim 1 wherein displaying the capacity planning tool comprises displaying textual or graphical information describing a current configuration of the datacenter.

3. The method of claim 1 wherein accessing information comprises accessing a list of hardware and software deployed in the datacenter, as well as one or more configuration settings related to the resources in the datacenter.

4. The method of claim 1 wherein accessing information comprises accessing the information through a programmatic application-programming interface (API) for accessing the configuration data store that stores the configuration information.

5. The method of claim 1 wherein accessing information comprises querying configuration information from one or more datacenter resources to dynamically determine the current configuration.

6. The method of claim 1 wherein receiving asset information comprises receiving information describing one or more new network devices, storage assets, or computing assets available for deployment.

7. The method of claim 1 wherein receiving one or more configuration changes comprises assigning a pool of networking addresses to one or more new resources.

8. The method of claim 1 wherein receiving one or more configuration changes comprises assigning one or more roles to particular hardware resources.

9. The method of claim 1 wherein receiving one or more configuration changes comprises specifying credentials and routes for access between one or more resources.

10. The method of claim 1 further comprising storing configuration changes in the configuration data store at multiple stages, including before and after validation.

11. The method of claim 1 wherein validating changes comprises determining whether deploying the new configuration would break one or more previously routes available under the existing configuration.

12. The method of claim 1 further comprising, upon detecting any configuration errors, displaying each configuration error to the administrator for resolution.

13. The method of claim 1 further comprising, upon detecting any configuration errors, rolling back the failed configuration to leave the datacenter in a consistent state.

14. A computer system for dynamic reconfiguration of resources in a datacenter that constitute a compute cloud, the system comprising:
a processor and memory configured to execute software instructions embodied within the following components;
a configuration data store that stores configuration information describing the hardware components, software components, and configuration of one or more datacenter resources;
a configuration access component that retrieves configuration information from the configuration data store;
a configuration specification component that receives a description of a new configuration for the datacenter resources;
a configuration validation component that validates the received description for each new configuration of the datacenter resources;
a deployment engine component that receives a selection of a new configuration for the datacenter resources and applies the configuration by modifying configuration of hardware and software components to carry out the new configuration; and
a deployment validation component that validates the applied new configuration to catch any errors not identified by the pre-deployment validation.

15. The system of claim 14 wherein the configuration data store includes information describing an active deployment as well as one or more new or potential future deployment configurations defined by an administrator for deployment to the datacenter resources.

16. The system of claim 14 wherein the configuration access component provides the retrieved information to one or more tools or other applications through a programmatic application-programming interface (API).

17. The system of claim 14 wherein the configuration specification component provides a user interface for modifying and receiving new configuration data through a reconfiguration tool displayed to the administrator.

18. The system of claim 14 wherein the configuration validation component ensures that particular computers can communicate based on specified network settings.

19. The system of claim 14 wherein the deployment engine component determines a delta between a current configuration and the new configuration and invokes one or more hardware and software configuration interfaces to apply the differences determined by the delta.

20. A computer-readable storage medium comprising instructions for controlling a computer system to deploy a previously defined new datacenter configuration, wherein the instructions, upon execution, cause a processor to perform actions comprising:
receiving a command from an administrator that instructs the system to deploy a previously defined new configuration to a datacenter;
accessing the previously defined new configuration from a configuration data store associated with the datacenter;
accessing a current configuration of the datacenter with which to compare the new configuration to determine changes;
determining a configuration delta between the current configuration and the new configuration;
generating one or more reconfiguration work items that together will transition the configuration of the datacenter from the current configuration to the new configuration;
applying the generated reconfiguration work items to automatically reconfigure the datacenter from the current configuration to the new configuration; and
performing post-deployment validation to verify successful reconfiguration of the datacenter.
